(19) United States
(12) Patent Application Publication
(10) Pub. No.: US 2015/0310529 A1
(43) Pub. Date: Oct. 29, 2015

(54) WEB-BEHAVIOR-AUGMENTED RECOMMENDATIONS

(71) Applicant: Microsoft Corporation, Redmond, WA (US)

(72) Inventors: Royi Ronen, Tel Aviv (IS); Elad Yom-Tov, Hoshaya (IS); Elad Ziklik, Modiin (IS); Gal Lavee, Tel Aviv (IS)

(73) Assignee: Microsoft Corporation, Redmond, WA (US)

(21) Appl. No.: 14/262,948

(22) Filed: Apr. 28, 2014

(51) Int. Cl. G06Q 30/06

(52) U.S. Cl. CPC G06Q 30/0631

(57) ABSTRACT

One or more web-behavior-augmented recommendation servers augment catalog interaction data between consumers and a catalog of products with collected online web behavior data associated with individual users. The online web behavior data represents online web behavior of the each consumer outside of the catalog of products and can improve the accuracy of product recommendations, which then be presented to an individual consumer via a computer user interface.

### BACKGROUND

Recommendation systems can be used to recommend new products (e.g., goods, services, software applications, video games, etc.) to consumers. However, typical systems have a limited amount of relevant data (e.g., about a user's online purchasing habits within an online catalog) with which to generate accurate recommendations. Such users can be referred to as “cold users.” When little information is available on a consumer's previous purchases, prediction of useful products can be challenging and/or unhelpful.

### SUMMARY

Implementations described and claimed herein may address the foregoing by augmenting catalog interaction data between consumers and a catalog of products with collected online web behavior data associated with individual users. The online web behavior data represents online web behavior of the each consumer outside of the catalog of products and can improve the accuracy of product recommendations, which then be presented to an individual consumer via a computer user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system for providing web-behavior-augmented recommendations.

FIG. 2 illustrates an example user interface presenting web-behavior-augmented recommendations of software applications.

FIG. 3 illustrates matrix factorization of a sparse matrix representing augmented catalog interaction data.

FIG. 4 illustrates a mathematical product of a user factor matrix and a feature factor matrix of a sparse matrix representing augmented catalog interaction data.

FIG. 5 illustrates a mathematical product of a feature factor matrix of a first feature and a feature factor matrix of a second feature, the factor matrices being associated with a sparse matrix representing augmented catalog interaction data.

FIG. 6 illustrates augmentation of catalog interaction data using sparse matrix expansion.

FIG. 7 illustrates augmentation of catalog interaction data using sparse matrix injection.

FIG. 8 illustrates example operations for providing web-behavior-augmented recommendations.

FIG. 9 illustrates an example system that may be useful in implementing the described technology.

### DETAILED DESCRIPTION

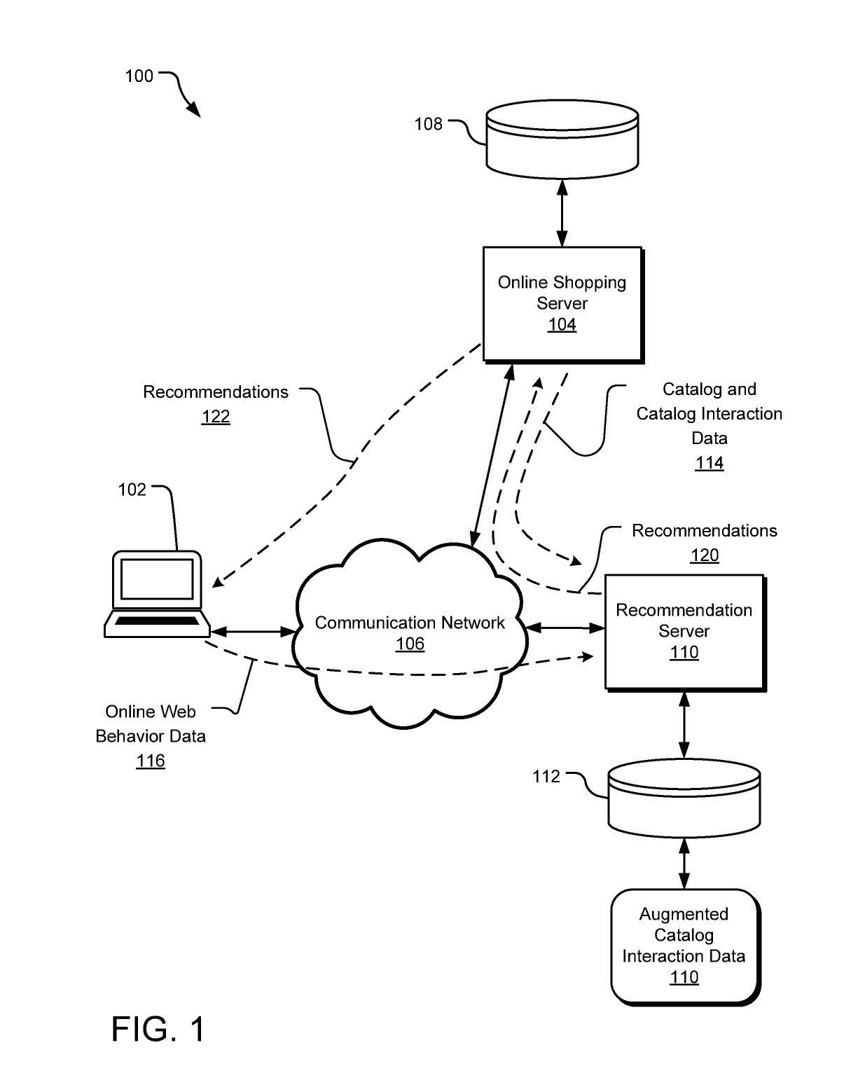

FIG. 1 illustrates an example system 100 for providing web-behavior-augmented recommendations. A user computing device 102 communicatively couples to one or more online shopping servers 104 via a communication network 106. The one or more online shopping servers 104 have an access to one or more storage devices 108, which records catalog interaction data between a user and one or more catalogs. For example, an online shopping server 104 may provide an online shopping service for clothing, and the storage device 108 records catalog interaction data relating to individual users (e.g., catalog products a user browses, purchases, returns, gifts, etc.). The catalog interaction data can be used to predict other products in which each user may be interested. Nevertheless, when the user has interacted with no items or few items in a particular catalog, the level of confidence in any particular recommendation may be tenuous.

The user computing device 102 communicatively couples to one or more recommendation servers 110, which collects catalog data (e.g., product names, numbers, prices, characteristics, etc.) of the online shopping server 104 and catalog interaction data relating to individual users. The one or more recommendation servers 110 also collect online web behavior data for individual users, including without limitation of or more of the following type of data: web browsing history, cookie data, user-inputted universal resource identifiers, toolbar input, social network data, and online search queries. Such online web behavior data is generally independent of the online shopping server 104 and its catalog and is not considered to be interaction between the user and the catalog of products. One or more storage devices 112 accessible by the one or more recommendation servers 110 can store catalog data and catalog interaction data received from the online shopping server 104. Further, the one or more storage devices 112 may also store online web behavior data 116 relating to individual users, which can be collected from the user computing device 102 or other online web behavior data sources (e.g., search engines, social networks, feedback from websites that are visited, etc.).

One example of online web behavior data includes a history of websites visited by the user. Such history may be limited to a recent period of time, in order to be associated with the user's more recent interests. For example, the user may have visited certain travel websites in the past month, particularly those relating to Israel. Such information may be used to augment the catalog interaction data for a given catalog to improve the accuracy of recommendation of products from the catalog that are presented to a user.

Given the catalog interaction data 114 and the online web behavior data 116 for a group of users, the one or more recommendation servers 110 can generate product recommendations for a given catalog and a given user. In one implementation, the catalog interaction data 142 is augmented by the online web behavior 116 may be recorded in the one or more storage devices 112, and the one or more recommendation servers 110 uses matrix factorization of a sparse matrix representing the augmented catalog interaction data 118 to generate one or more recommendations 120, which are communicated directly to the user computing device 102. In a more typical implementation, the recommendations 120 are communicated to the online shopping server 104, which can refine the recommendations before passing the recommendations 122 to the online shopping server 104. The recommendations 122 are presented to the user via a computer user interface of the user computing device 102, which may be a workstation, laptop computer, mobile computing/communication device, tablet computer, wearable device, etc. In some circumstances, the user can elect to interact with the catalog of the online shopping server 104 based on the presented recommendation. Such interaction can then be added to the catalog interaction data pertaining to the user.

Using example augmentation of data available to a one or more recommendation servers as described, an individual user may be converted from a “cold user” (a user with little information on which to base a recommendation) to a “warm user” (a user with more information on which to base a recommendation). Likewise, a certain product may be converted from a “cold product” (a product with little purchase information on which to base a recommendation) to “warm product” (a product with more purchase information on which to base a recommendation). Such augmentation can lead to dramatically more accurate and helpful recommendations for a given user.

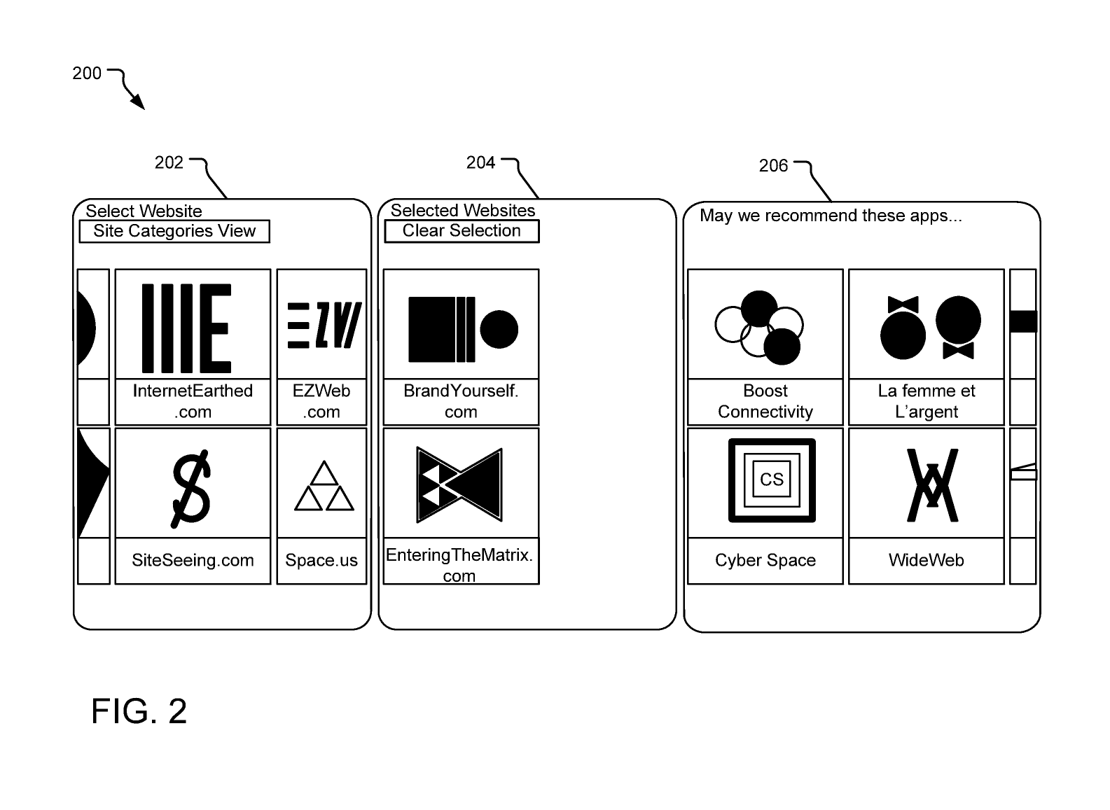

FIG. 2 illustrates an example user interface 200 presenting web-behavior-augmented recommendations 206 of software applications offered by an online software application store (not shown). In the illustrated implementation, online web behavior is collected based on suggested websites 202 and selected websites 204. For example, the user interface 200 presents suggested websites 202 to the user. The user can select one or more of the suggested websites as being websites of interest (e.g., recently visited websites, favorite websites, etc.). The selected websites 204 are displayed in the middle section of the user interface 200. Recommended software applications 206 are generated based on the user's past interaction with the online software application store (e.g., previously purchased apps) and on the selected websites 204.

In an alternative implementation, the online web behavior data is collected over time and in the background of browsing sessions of individual users. The collected online web behavior data is provided to one or more recommendation servers, which are accessed by an online shopping server to receive recommendations based on the augmented catalog interaction data (e.g., catalog interaction data of individual users augmented by online web behavior of individual users). An example user experience may include logging into an online shopping server and being presented with highly accurate recommendations of products anticipated to be of interested to the logged-in user. In one example scenario, a user visiting a clothing site may be presented with warm weather clothing recommendations, influenced in part by the user's recent browsing through travel blogs of tropical locations.

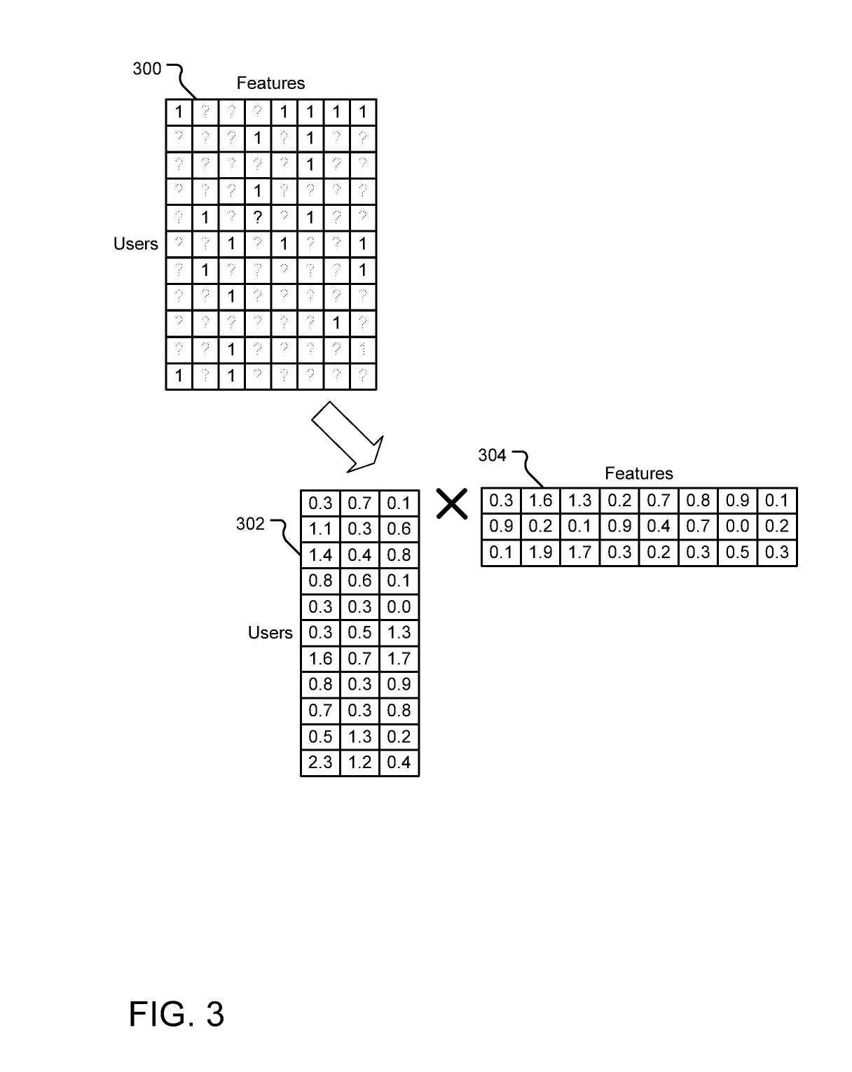

FIG. 3 illustrates matrix factorization of a sparse matrix 300 representing augmented catalog interaction data. It should be understood however that recommendations may be generated using techniques other than matrix factorization (e.g., neighborhood methods, methods that combines collaborative filtering and with another method, such as content-based filtering, and other known and unknown techniques). Matrix factorization is merely provided as an example technique.

Matrix factorization, as the name suggests, is a technique to factor a matrix by finding two or more matrices that can be multiplied together to yield the original matrix. Matrix factorization may be used to discover latent relationships between two or more different kinds of data (e.g., users and products they may be interested in purchasing).

The sparse matrix 300 is shown and described to include augmented catalog interaction data, including catalog interaction data between individual users and products offered in a catalog plus online web behavior data of the users (or some subset thereof). For the sparse matrix 300, the users correspond to the rows and the features (e.g., products, web behavior, etc.) correspond to the columns. The values of the elements of the sparse matrix 300 are substantially unknown—as indicated by the “?” symbols (e.g., the sparse matrix indicates that the users corresponding to the first row and last row purchased a product corresponding to the first column, but no such information is known for the other users relating to that product), while the feature information known about the users is indicated as a “1” value in the appropriate elements of the sparse matrix 300 of augmented catalog interaction data.

As such, in matrix factorization, two compact factor matrices 302 and 304 (e.g., a user factor matrix 302 and a feature factor matrix 304) are generated that can be multiplied together (e.g., to find a dot product) to yield the sparse matrix 300. One method of generating the factor matrices is to select a k value specifying the number of columns of the user factor matrix 302 and the number of rows of the feature factor matrix 304. In the illustrated example, a k value of 3 is chosen, although other k values may be chosen. The elements of the factor matrices 302 and 304 are seeded with initial values, and the dot product of the factor matrices 302 and 304 are compared to the known values of the sparse matrix 300. Based on the errors between the known values in the sparse matrix 300 and the corresponding values in the dot product of factor matrices 302 and 304, the factor matrices values are adjusted to minimize the errors (e.g., using methods such as gradient, simulated annealing, alternating least squares, etc.) The minimization operation yields factor matrices that produce a dot product having values in elements that substantially match the values in the elements of the original sparse matrix 300. As data in the sparse matrix 300 is supplemented, augmented, or otherwise changed, the factor matrices are updated in a similar fashion.

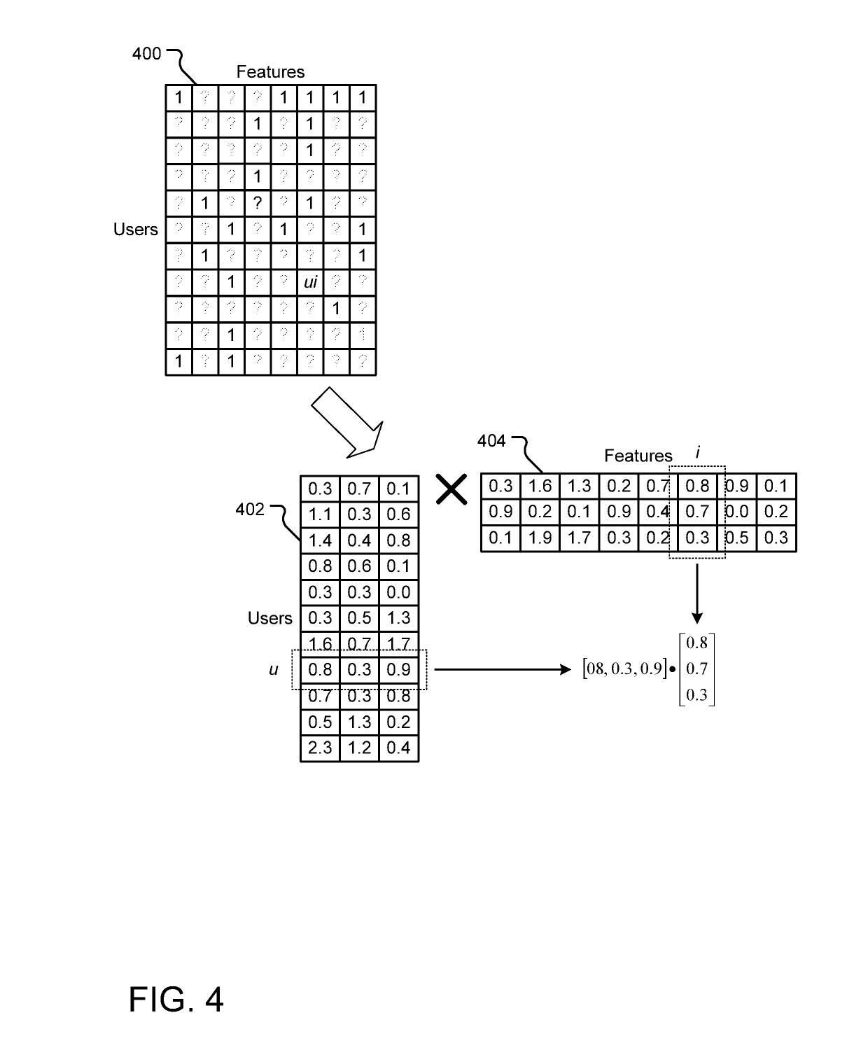

FIG. 4 illustrates taking a mathematical product of a user factor matrix 402 and a feature factor matrix 404 of a sparse matrix 400 representing augmented catalog interaction data. In this example, the goal is to determine a relationship between a user u and a feature i by taking the dot product of the row of the user factor matrix 402 and the column of the feature factor matrix 404. Because the sparse matrix 400 includes both catalog interaction data and online web behavior data for individual users, the factor matrices 402 and 404 incorporate the online web behavior data, providing improved modeling of recommendations over mere catalog interaction data.

The dot product of the factor matrix rows and columns yield a value representing a relationship between the user u and the feature i. Should this relationship value satisfied a recommendation condition (e.g., exceed a threshold) and the feature corresponds to a catalog product (rather than a website, search query, etc.), a recommendation server will identify the corresponding product as a recommendation for the user u.

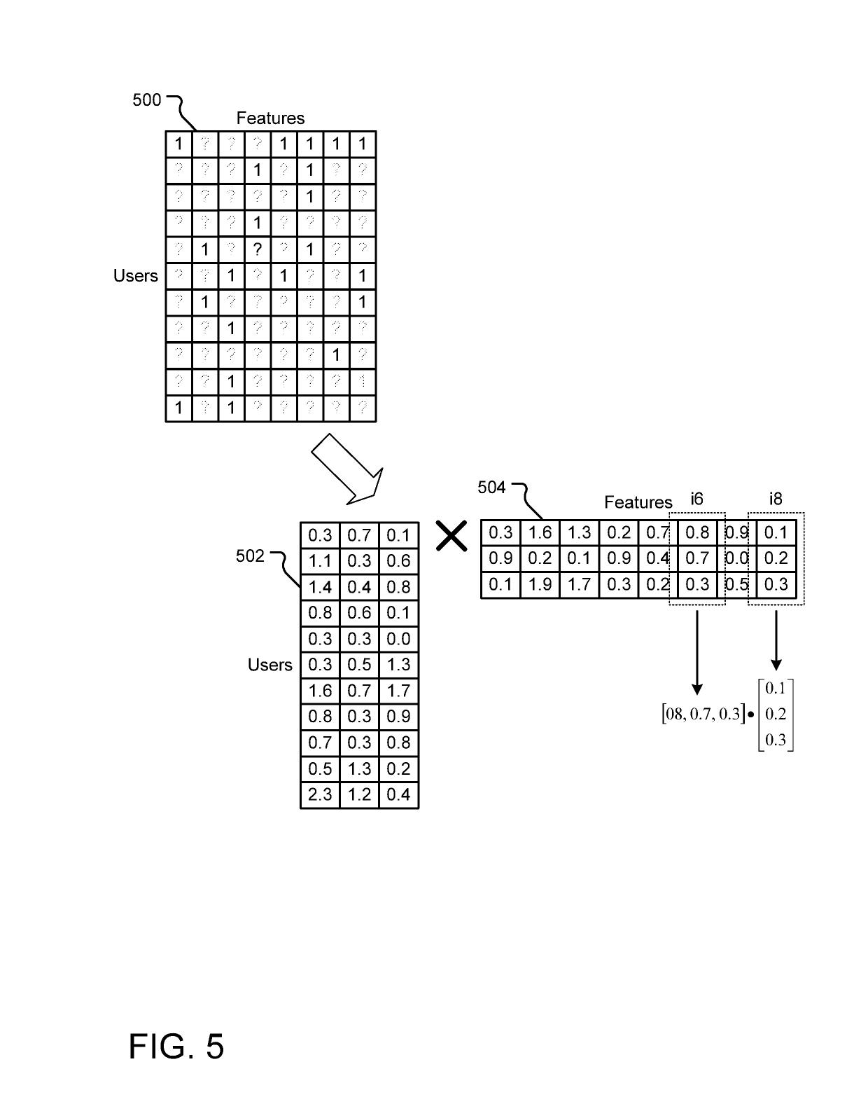

FIG. 5 illustrates a mathematical product of a feature factor matrix of a first feature i and a feature factor matrix of a second feature f, the factor matrices being associated with a sparse matrix representing augmented catalog interaction data. In this example, a goal is to determine a relationship between the feature i and the feature f by taking the dot product of the columns of the feature factor matrix 404 corresponding to each factor. The value of the dot product of these columns represents a measure of similarity between the two features (e.g., two products, a product and a website, etc.). A similar similarity measure can be used to identify “virtual products,” as discussed later.

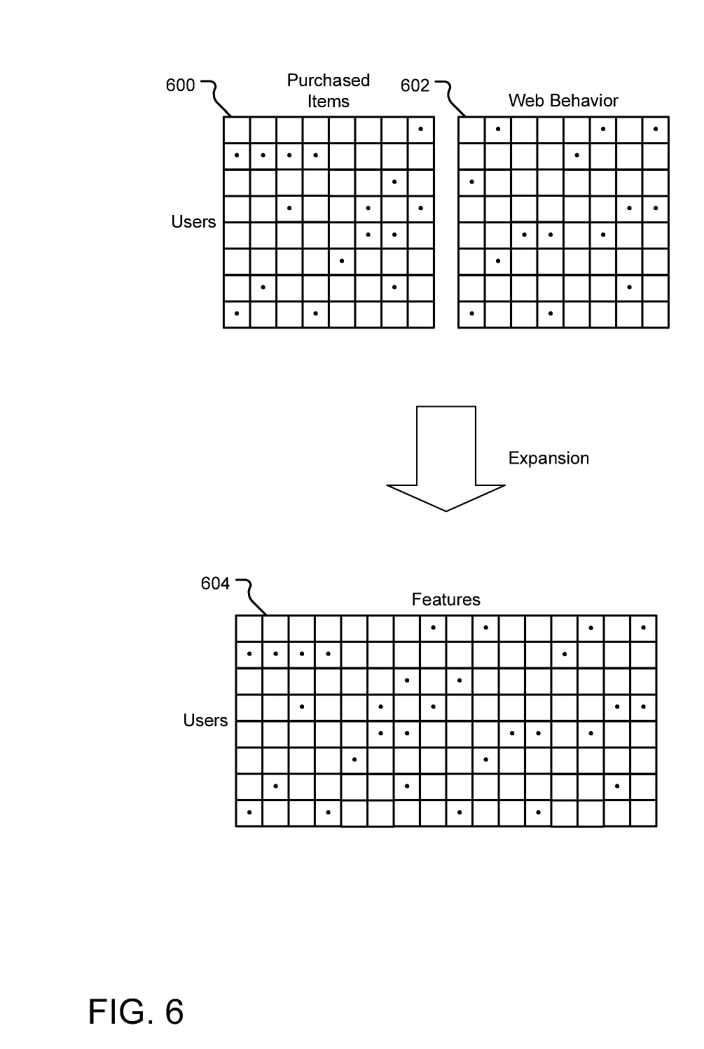

FIG. 6 illustrates augmentation of catalog interaction data 600 using sparse matrix expansion. The sparse matrix of catalog interaction data 600 is augmented with a sparse matrix of online web behavior data 602 by concatenating the two sparse matrices 600 and 602 together to yield a sparse matrix of augmented catalog interaction data 604. Recommendation techniques, such as those described with regard to matrix factorization in FIGS. 3, 4, and 5, as well as other recommendation techniques, may be employed using the sparse matrix of augmented catalog interaction data 604 to generate improved recommendations for a given user.

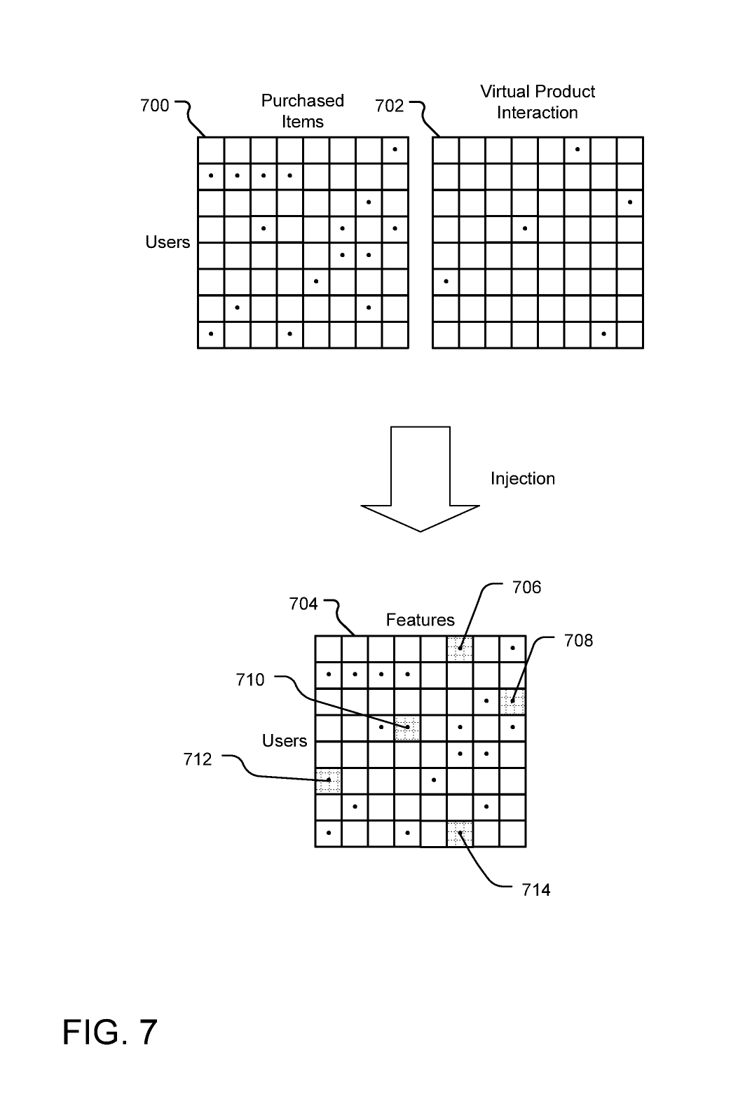

FIG. 7 illustrates augmentation of catalog interaction data 700 using sparse matrix injection. The sparse matrix of catalog interaction data 700 is augmented with online web behavior data based on virtual product interaction 702 by determining a relationship between a feature of online web behavior (e.g., a visited web site, a search query) and a product. The similarity measure, such as that discussed with regard to FIG. 5, can be used to determine such relationships, although other methods of identifying such relationships may be employed including heuristics and manual parameterization. With sparse matrix injection, specific online web behavior serves as a proxy for interaction between a user and a product in a catalog. For example, if a similarity measure satisfies a similarity condition (e.g., exceeds threshold) between a website and a product, the user's web behavior can be deemed a “virtual product interaction,” resulting in a relationship value being injected into the sparse matrix 700 for that user and product, as shown in augmented catalog data 704 as values 706, 708, 710, 712, and 714. Recommendation techniques, such as those described with regard to matrix factorization in FIGS. 3, 4, and 5, as well as other recommendation techniques, may be employed using the sparse matrix of augmented catalog interaction data 704 to generate improved recommendations for a given user.

Virtual products may be derived from web behavior, as exemplified by implementations described below. In one implementation, virtual products are those products that are usually bought or viewed within the same session at a given website. In this case, a table of the number of times a website is visited within the same session as a given product is constructed according to some sample data. The most frequent item purchased in the same session at a website or websites is identified as a “virtual product” and is entered into the catalog matrix when the website or websites are browsed by a user. In another implementation, only the last several (for example, 5) websites browsed before a product are considered. In this case, short-term purchase intentions can be discovered. In another embodiment, instead of choosing the most popular websites in the two methods above, the most unusual product is chosen as the virtual product, where an product is deemed unusual if the probability that it will be visited in the same session at a website divided by the average probability of visiting that item, regardless of the website, is greatest. Other derivations may be employed.

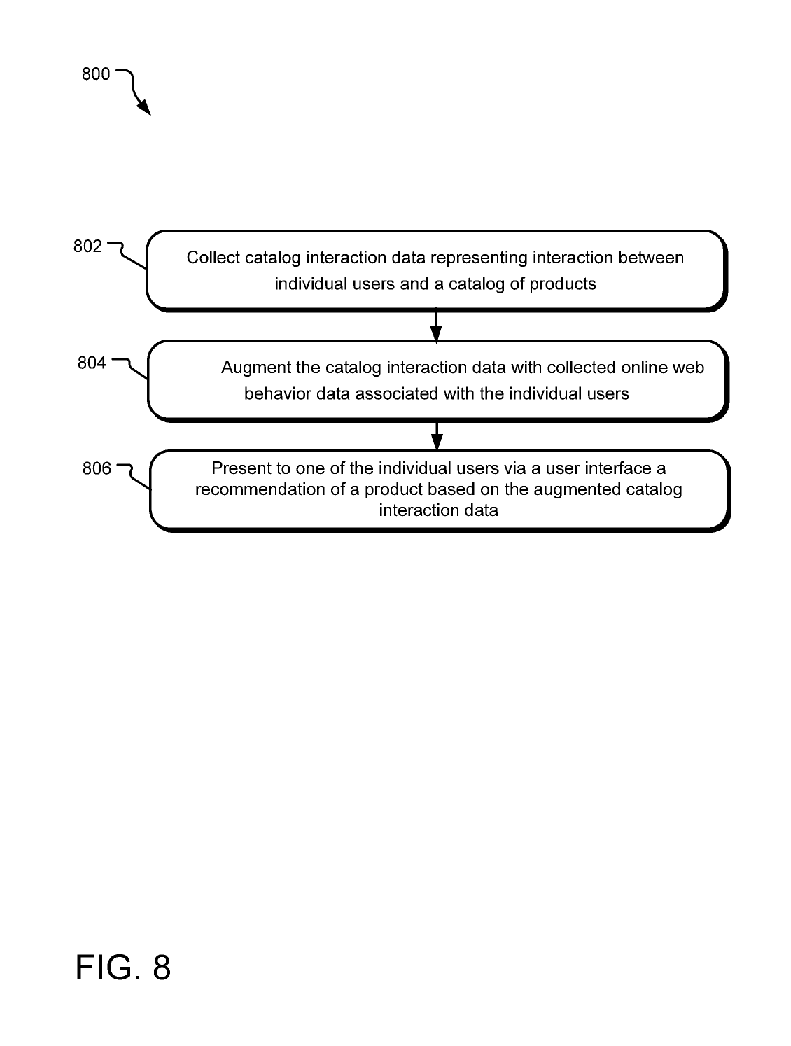

FIG. 8 illustrates example operations 800 for providing web-behavior-augmented recommendations. A collecting operation 802 collects catalog interaction data representing interaction between individual users and a catalog of products. An augmenting operation 804 augments the catalog interaction data with collected online web behavior with the individual users. The online web behavior data represents online web behavior of the each user outside (e.g., not with) of the catalog of products. Sparse matrix expansion and injection are example methods of augmentation, although other methods of augmenting catalog interaction data with online web behavior data may be employed. A presentation operation 806 presents a recommendation to one of the individual users. The recommendation was generated based on the augmented catalog interaction data. Matrix factorization methods and other methods may be used to generate the recommendation.

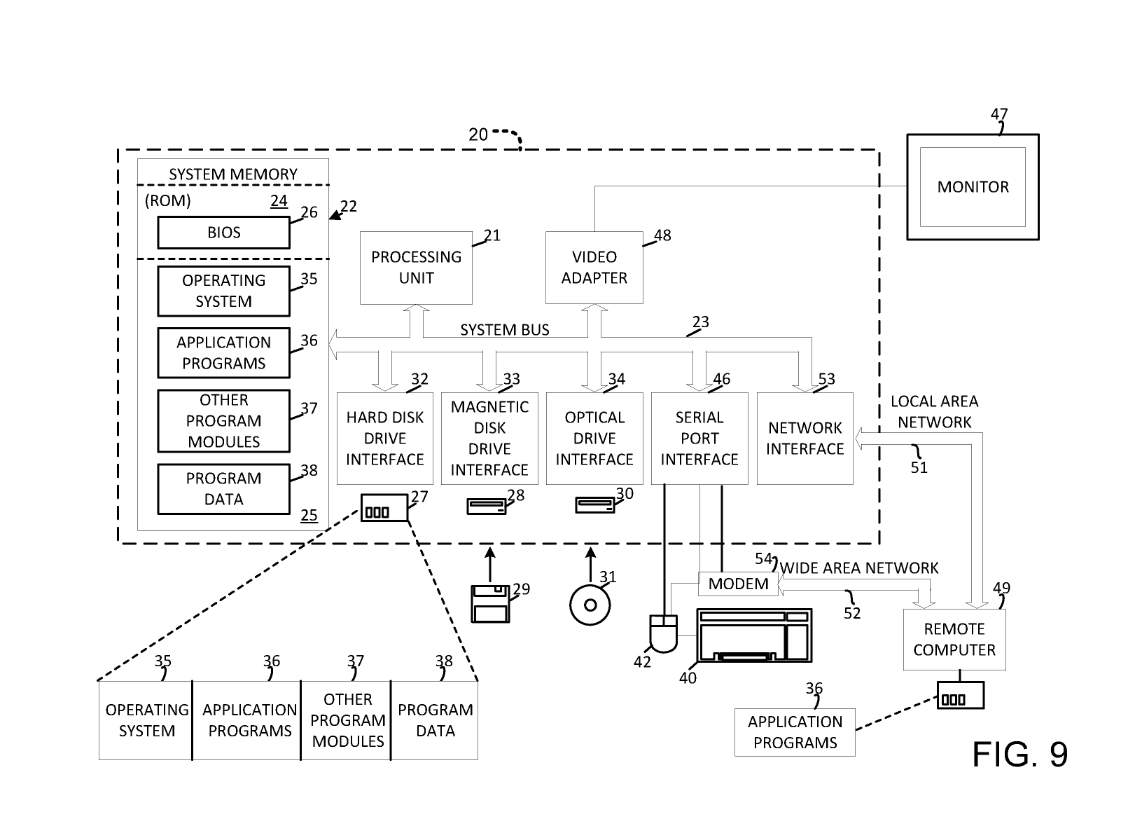

FIG. 9 illustrates an example system that may be useful in implementing the described technology. The example hardware and operating environment of FIG. 9 for implementing the described technology includes a computing device, such as general purpose computing device in the form of a gaming console or computer 20, a mobile telephone, a personal data assistant (PDA), a set top box, or other type of computing device. In the implementation of FIG. 9, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 9. The logical connections depicted in FIG. 9 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, one or more recommendation servers, one or more online shopping services, and other engines and services may be embodied by instructions stored in memory 22 and/or storage devices 29 or 31 and processed by the processing unit 21. Catalogs, catalog interaction data, online web behavior data, recommendations, and other data may be stored in memory 22 and/or storage devices 29 or 31 as persistent datastores. Further, a service server represents hardware and/or software configured to provide service functionality for network-connected systems. Such services may be implemented using a general purpose computer and specialized software (such as a server executing service software), a special purpose computing system and specialized software (such as a mobile device or network appliance executing service software), or other computing configurations.

The terms “module,” “program,” “service,” and “engine” may be used to describe an aspect of computing system 20 that is implemented to perform one or more particular functions. In some cases, such a module, program, service, or engine may be instantiated via processing unit 21 executing instructions held by system memory 22. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

The computer 20 may include a variety of tangible computer-readable storage media and intangible computer-readable communication signals. Tangible computer-readable storage can be embodied by any available media that can be accessed by the computer 20 and includes both volatile and nonvolatile storage media, removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by the computer 20. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

The implementations of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A processor-implemented method comprising:
collecting catalog interaction data representing interaction between individual users and a catalog of products;
augmenting the catalog interaction data with collected online web behavior data associated with one or more of the individual users, the online web behavior data representing online web behavior of the each user outside of the catalog of products; and
transmitting a recommendation of a product based on the augmented catalog interaction data for presentation in a user interface to one of the individual users.

2. The processor-implemented method of claim 1 wherein the products include services.

3. The processor-implemented method of claim 1 wherein the products include software applications.

4. The processor-implemented method of claim 1 wherein the catalog interaction data is represented in one or more data structures as a sparse matrix of the catalog interaction data, and the augmenting operation comprises:
expanding the sparse matrix by concatenating a sparse matrix of the web behavior.

5. The processor-implemented method of claim 1 wherein the catalog interaction data is represented in one or more data structures as a sparse matrix of the catalog interaction data, and the augmenting operation comprises:
determining associations between particular online web behavior corresponding interaction between a user performing the particular online web behavior and a product from the catalog of products to identify the associated product as a virtual product; and
injecting the virtual product element into the sparse matrix of catalog interaction data.

6. The processor-implemented method of claim 1 wherein the augmented catalog interaction data is represented in one or more data structure as a sparse matrix and the transmitting operation comprises:
performing matrix factorization on the sparse matrix of the augmented catalog interaction data to produce a user factor matrix and a feature factor matrix; and
identifying a product from the catalog for the recommendation if a mathematic product of a user factor matrix associated with the one of the individual users and the feature factor matrix of the identified product satisfies a recommendation condition.

7. The processor-implemented method of claim 6 wherein the mathematic product is a dot product of the user factor matrix and the feature factor matrix.

8. The processor-implemented method of claim 1 wherein the online web behavior includes one or more of group of online web behaviors including online search queries, toolbar input, social network data, user-inputted universal resource identifiers, browsing history, and cookie data.

9. One or more tangible computing processor-readable storage medium articles of manufacture storing programming instructions executable by a computing processor for performing a computing process, the computing process comprising:
collecting catalog interaction data representing interaction between individual users and a catalog of products;
collecting online web behavior data associated with one or more of the individual users, the online web behavior data representing online web behavior of the each user outside of the catalog of products;
augmenting the catalog interaction data with the collected web behavior data; and
transmitting a recommendation of a product based on the augmented catalog interaction data for presentation in a user interface to one of the individual users.

10. The one or more tangible computing processor-readable storage medium articles of manufacture of claim 9 wherein the products include services.

11. The one or more tangible computing processor-readable storage medium articles of manufacture of claim 9 wherein the products include software applications.

12. The one or more tangible computing processor-readable storage medium articles of manufacture of claim 9 wherein the catalog interaction data is represented in one or more data structures as a sparse matrix of the catalog interaction data, and the augmenting operation comprises:
expanding the sparse matrix by concatenating a sparse matrix of the web behavior.

13. The one or more tangible computing processor-readable storage medium articles of manufacture of claim 9 wherein the catalog interaction data is represented in one or more data structures as a sparse matrix of the catalog interaction data, and the augmenting operation comprises:
determining associations between particular online web behavior corresponding interaction between a user performing the particular online web behavior and a product from the catalog of products to identify the associated product as a virtual product; and
injecting the virtual product element into the sparse matrix of catalog interaction data.

14. The one or more tangible computing processor-readable storage medium articles of manufacture of claim 9 wherein the augmented catalog interaction data is represented in one or more data structure as a sparse matrix and the transmitting operation comprises:
performing matrix factorization on the sparse matrix of the augmented catalog interaction data to produce a user factor matrix and a feature factor matrix; and
identifying a product from the catalog for the recommendation if a mathematic product of a user factor matrix associated with the one of the individual users and the feature factor matrix of the identified product satisfies a recommendation condition.

15. The one or more tangible computing processor-readable storage medium articles of manufacture of claim 14 wherein the mathematic product is a dot product of the user factor matrix and the feature factor matrix.

16. The one or more tangible computing processor-readable storage medium articles of manufacture of claim 9 wherein the online web behavior includes one or more of group of online web behaviors including online search queries, toolbar input, social network data, user-inputted universal resource identifiers, browsing history, and cookie data.

17. A system comprising:
one or more recommendation server devices configured to augment collected catalog interaction data representing interaction between individual users and a catalog of products with collected online web behavior data associated with one or more of the individual users, the online web behavior data representing online web behavior of the each user outside of the catalog of products, the one or more recommendation server devices being further configured to identify a product for recommendation to one of the individual users based on the augmented catalog interaction data; and
one or more interfaces communicatively coupled to the one or more recommendation server devices and configured to transmit a recommendation of a product based on the augmented catalog interaction data for presentation in a user interface to one of the individual users.

18. The system of claim 17 wherein the catalog interaction data is represented in one or more data structures as a sparse matrix of the catalog interaction data, and the augmenting operation comprises:
expanding the sparse matrix by concatenating a sparse matrix of the web behavior.

19. The system of claim 17 wherein the catalog interaction data is represented in one or more data structures as a sparse matrix of the catalog interaction data, and the one or more recommendation server devices are further configured to augment the catalog interaction data by determining associations between particular online web behavior corresponding interaction between a user performing the particular online web behavior and a product from the catalog of products to identify the associated product as a virtual product and injecting the virtual product element into the sparse matrix of catalog interaction data.

20. The system of claim 17 wherein the augmented catalog interaction data is represented in one or more data structure as a sparse matrix and the one or more recommendation server devices are further configured to perform matrix factorization on the sparse matrix of the augmented catalog interaction data to produce a user factor matrix and a feature factor matrix and identifying a product from the catalog for the recommendation if a mathematic product of a user factor matrix associated with the one of the individual users and the feature factor matrix of the identified product satisfies a recommendation condition.
